(19) United States
(12) Patent Application Publication
(10) Pub. No.: US 2009/0098385 A1
(43) Pub. Date: Apr. 16, 2009

(54) MULTI-LAYERED BELT

(75) Inventors: Thomas Kaemper, Burgwedel (DE); Torsten Buch, Hannover (DE); Claudius Hayduk, Hannover (DE); Michael Van Well, Garbsen (DE)

Correspondence Address: DARBY & DARBY P.C., P.O. BOX 770, Church Street Station, New York, NY, 10008-0770, US

(73) Assignees: FORBO SIEGLING GMBH, Hannover (DE); TECHNOGEL KOENIGSEE GmbH, Berlingerode (DE)

(21) Appl. No.: 11/813,723

(22) PCT Filed: Jan. 18, 2006
(86) PCT No.: PCT/DE2006/000053

§ 371 Date: Oct. 20, 2008

(30) Foreign Application Priority Data
Jan. 18, 2005 (DE) 10 2005 002 427.0

(51) Int. Cl. B32B 27/40; B29D 29/00

(52) U.S. Cl. 428/422.8; 156/137

(57) ABSTRACT

A multi-layered belt, in particular a continuous running and/or transport and/or processing belt, includes a traction layer and a functional layer that contains a gel. To reduce the stress placed on the transported goods, in particular persons, the gel is an unplasticized gel and the functional layer consist of a coating containing the interspersed gel. In addition, to a method for producing a belt of this type is provided, in which the gel is poured in a continuous method onto the traction layer and a mixer and delivery unit is guided back and forth in a reversible manner perpendicular to the displacement direction of the traction layer in such a way that a gel layer with a uniform thickness is applied to the traction layer. Furthermore, the use of said belt as a running belt for persons, in particular as a running belt for training and/or fitness equipment is described.

The invention relates to a multi-layered belt, especially to a continuous treadmill belt and/or to a conveyor belt and/or a processing belt, having a traction layer and a functional layer that contains a gel. The invention also relates to a method for the production of one of the above-mentioned belts. Furthermore, the invention relates to the use of one of the above-mentioned belts.

In particular, the invention relates to a multi-layered belt configured as a continuous conveyor belt or processing belt having a gel coating on one support side.

### BACKGROUND

Generally speaking, multi-layered belts are used in actual practice as conveyor belts or processing belts but also as treadmill belts, and thus belong to the state of the art.

An embodiment commonly employed in actual practice comprises synthetic conveyor belts that are made up of several layers, one or more of which—especially a layer made of a fabric or a fiber arrangement—assumes the function of transmitting the tractive force. Another layer, namely, an outer layer, forms a support layer on which the material being conveyed—or, if applicable, the person exercising on the treadmill belt—is transported, and another layer, namely, an inner layer, forms the running side that is in contact with a structure that supports the conveyor belt. Intermediate layers can also be provided.

Conveyor belts and processing belts, which are also employed as treadmill belts, usually have a support layer comprising a coating of PVC (polyvinyl chloride) or polyurethane with a thickness of just a few tenths of a millimeter. This very thin support layer normally has the function of providing a non-slip surface which, on the one hand, ensures secure footing for the person exercising on the treadmill belt or, generally speaking, ensures that the material being conveyed on the conveyor belt is securely held and, on the other hand, protects the layer that performs the function of transmitting the tractive force against mechanical damage. A drawback of conveyor belts and processing belts configured in this manner and employed as treadmill belts is that they lack any cushioning properties. On the one hand, this causes severe mechanical wear and tear brought about by localized stress during use by a person and, on the other hand, gives rise to a high biomechanical stress on the person or on her/his musculoskeletal and locomotor system such as joints and bones in the legs and spinal column.

Japanese patent application JP 10-329915 A describes a conveyor belt having a gel layer and designed to convey fruit. Here, the gel layer configuration involves the use of a plasticizer that is physically bonded to a polyurethane layer. This results in several disadvantages. A plasticizer can escape from the material that contains it as a result of migration, abrasion and evaporation or else it can be dissolved out by means of a chemical process. This changes the mechanical properties of such a gel, even to the point of completely eliminating the gel characteristics. Moreover, the hardness of a gel thus configured can only be adjusted within very narrow limits.

German patent application DE 100 56 097 A1 describes a suction belt having a flexible material in an intermediate layer that is arranged in geometrical shapes (cushions). Moreover, here a covering layer is joined to the traction support by rivets. Mention is made here of a gel as a possible flexible material for the intermediate layer.

German utility model DE 201 11 684 U1 describes a conveyor belt that has strips with troughs in the elastic material on one support side in order to hold wheels during the transportation of vehicles. The elastic material is provided here to distribute the pressure in order to reduce the surface pressure exerted by the conveyor belt onto a substrate. A fluid, a gas, a liquid or a gel are mentioned as possible materials for the configuration of the elastic material.

Gels based on polyurethanes are fairly well known. For instance, the gels claimed in European patent specification EP 0 057 838 B1 allow a very good pressure distribution under load. These gels are characterized by a low characteristic value, that is to say, by so-called undercuring. These gels are produced by reacting polyisocyanates with long-chain polyols that have to be free of short-chain fractions. Furthermore, the product of the functionalities of the polyol and the isocyanate has to be at least greater than 5.2. The gels are dimensionally stable and yet flowable within certain limits. Cushions intended for preventing bedsores are an outstanding application. Examples of other applications are mattresses, mattress inserts, car seats, soles, insert soles and upholstered furniture. These polyurethane gels are characterized not only by their dimensional stability but also by their excellent mechanical properties and tackiness. The tackiness is often felt to be detrimental. By enclosing the gel with various types of coatings, however, it is possible to obtain a non-tacky surface.

European patent specification EP 0 511 570 B1 provides protection for improved gels consisting of polyols and polyisocyanates that have a low characteristic value and that are produced from mixtures of long-chain and short-chain polyethers. These gels are more suitable in terms of processing and can be used as padding in shoes, bicycle saddles and seats, as cushioning to prevent injury, in face masks and in padding under horse saddles as well as in other applications.

### SUMMARY OF THE INVENTION

An object of the present invention is to provide a multi-layered belt of the above-mentioned type which, while having reliable and durable mechanical properties, reduces the stress exerted on the material being transported, especially on persons. A further or alternate object of the present invention is to provide a method for the production of such a belt as well as the advantageous use of such a belt.

The invention yields a multi-layered belt especially configured as a continuous conveyor belt or processing belt that has both a wear-proof and highly stressable surface as well as a coating on the support side that gives the belt cushioning properties. These cushioning properties reduce the mechanical wear and tear on the running side as well as the biomechanical stress on a person using the belt on a treadmill.

Moreover, the cushioning properties bring about advantages during the transportation of impact-sensitive goods or when the conveyor belt is being used for slanted conveyance in which the goods to be transported are transported upwards or downwards along an incline. Advantageously, the materials which are used to form the gel layer and which constitute the basis of this invention retain their cushioning properties at a constant level over a prolonged period of use, even after many reversals of load. Moreover, this conveyor belt and processing belt can be made into a continuous belt by employing the conventional methods for synthetic conveyor belts. The joint can be configured, for example, in the form of an overlapping joint or a Z-joint (dovetail joint).

Moreover, thanks to the gel used here, the invention brings about a cushioning of thrust loads. When the belt is being used as a treadmill belt, the person generates not only pressure loads onto the belt surface that act perpendicular to the belt surface because of the impact of the feet, but also thrust loads parallel and tangential to the belt surface brought about by feet pushing off during the running movement. These thrust loads cause mechanical wear and tear to the belt coating, which can be minimized with the gel according to the invention. The use of the gel employed in the present invention has made it possible for the first time to cushion such thrust loads as well. At the same time, the cushioning of thrust loads constitutes a new, surprising application for the gel employed here since up until now, it had only been provided for application involving cushioning of forces in only one direction of action, namely, compressive forces, and not for cushioning forces that occur simultaneously in two directions that are perpendicular to each other, namely, pressure, tractive and thrust forces, as is the case with the invention.

Therefore, according to the invention, a multi-layered belt having a support layer and especially configured as a continuous conveyor belt or processing belt is provided wherein the support layer is configured as a gel layer, preferably connected to a fabric by means of an intermediate layer.

Here, the gel layer advantageously has a material thickness that is adapted to the envisaged conditions of use. In order to yield good cushioning properties, the thickness of the gel layer is preferably between 2.0 mm and 3.0 mm. The gel layer can be non-detachably bonded to a layer that is arranged on the support side, especially as the end of the belt on the support side, for instance, a plastic film or a coating.

Advantageously, unlike the gel known from Japanese patent application JP 10-329915 A, the hardness of the gel employed in the present invention can be varied over a wide range without the use of plasticizers. In contrast to German patent application DE 100 56 097 A1, the present invention has no suction openings, so the belt cannot be used as a suction belt. The belt according to the invention advantageously has a flat coating on the support side and the coating is not arranged in geometrical shapes. Support elements such as, for example, rivets, are not needed in the case of the invention.

The belt according to the invention can also make use of a protective layer that is configured as a film or a coating. At the same time, however, the invention also permits configuring such a protective layer as a functional layer in that it has, for example, texturing or structuring. Advantageously, the protective layer can have a sprayed-on coating.

The gels known from EP 0 057 838 B1 as well as EP 0 511 570 B1 can be produced without the use of plasticizers. The hardness and cushioning can be regulated over a wide range by appropriately selecting the components used and the mixing ratios.

Preferably, materials that yield a Shore L hardness of 50 are employed to create the gel layer for treadmill belts. The cushioning is then in a range that is typical of these gels, that is to say, of an elastomer, and it is relatively high. This is why the impact that occurs during running is very well cushioned and correspondingly lower stress is exerted on the spinal column,

The belt according to the invention is preferably produced in that first of all, an intermediate layer is applied onto a fabric that constitutes the traction layer. This can be done by using a doctor blade, by applying a calandered film or else by other methods employed in coating technology, which are optionally followed by a thermal treatment that creates the bond between the fabric and the intermediate layer.

Depending on the type of final product, an additional intermediate layer is applied onto the reverse side of this fabric during a second step. This is done by means of the same methods employed in the above-mentioned first process step.

In the next process step, the gel layer is poured onto the fabric in a continuous operation. This is done in that a reversing mixing and feeding unit is moved back and forth perpendicular to the direction of movement of the fabric, namely, in such a way that a gel layer with a uniform thickness is applied onto the fabric. If the gel layer is to be coated with a suitable plastic film, especially in the form of a protective layer, it is simultaneously fed to an appropriate device where this film is inseparably bonded to the gel layer; fundamentally speaking, the bond can be separable, for instance, if severe mechanical forces are applied, but the important aspect is that the bond is durable and especially that it can withstand stress brought about by kneading, so that it is inseparable under the normal operating conditions of the belt. A sprayed-on coating layer, for instance, can be provided instead of the plastic film.

Insofar as the desired embodiment of the final product calls for another fabric layer, this second fabric layer is coated with one or more additional intermediate layers in a subsequent process step of the coating operation according to the same methods as in the first process step. At the same time, in one of these process steps, the first fabric layer, which contains the gel layer, is combined with the other layer by means of a technique commonly employed in coating technology in such a way that both fabric layers are bonded, preferably glued together. This procedure is called lamination.

The non-continuous belt thus produced can be made continuous by means of a method commonly employed for synthetic conveyor belts. For this purpose, a suitable tool is employed to cut or stamp the belt ends that are to be joined, for instance, in a Z-shaped manner, that is to say, in zigzag form. Preferably, the cut is made in such a way that the cut edges are straight and neat and are not subjected to any considerable deformation. The belt ends thus prepared are inserted into each other and joined together in a heating press under exposure to pressure, temperature and optionally also using an adhesive, so that a so-called Z-joint or zigzag joint or dovetail joint is created.

Furthermore, the ends of the non-continuous belt are joined together in such a way that the belt ends are separated between preferably fabric layers in such a suitable manner that, in the joining zone, a fabric layer of one end overlaps with another fabric layer of the other end, without this causing a thickening in the joining zone due to a doubling of the layers. The overlapping ends are treated in an appropriate manner with an adhesive, so that after the joining in a heating press under the effect of pressure or pressure and temperature, the belt ends are joined together and form an overlapping joint.

At the same time, in order to protect the joint seam or generally the joining zone or a joining area on the support side, a film is glued or applied onto the joint seam in a heating press.

### BRIEF DESCRIPTION OF THE DRAWINGS

The invention permits various different embodiments. In order to further illustrate the basic principle, several embodiments thereof are schematically depicted in the drawing and will be described below. The following is shown:

FIG. 1—a side view of a section of a multi-layered belt having a joining area;

FIG. 2—a top view of an alternative joining area of the belt shown in FIG. 1.

### DETAILED DESCRIPTION

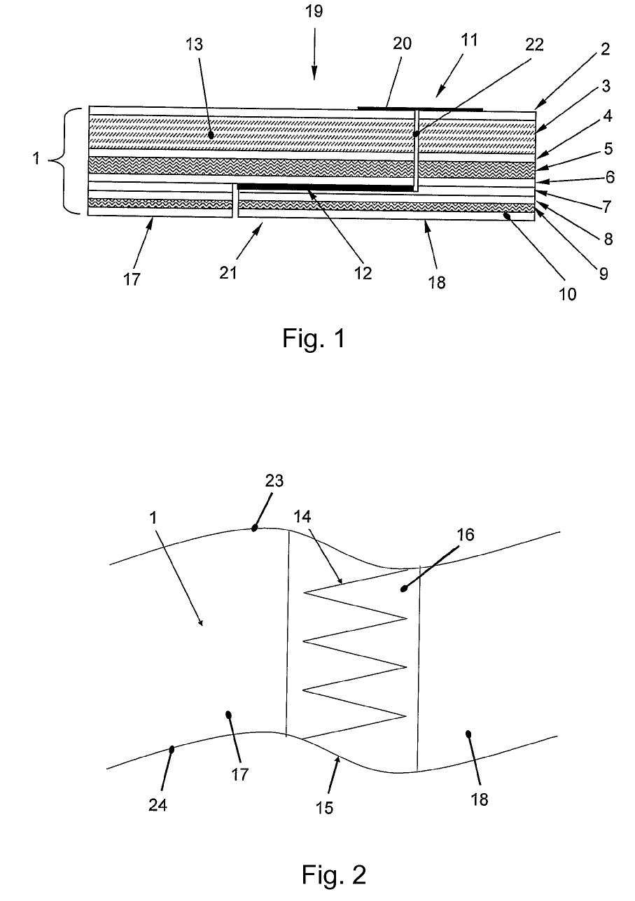

FIG. 1 shows a side view of a multi-layered belt 1, especially one configured as a continuous conveyor belt or processing belt or as a continuous treadmill belt, having a functional layer configured as a support layer 3 that contains a gel 13. The support layer 3 is configured as a gel layer having a layer thickness between 2 mm and 3 mm and it is provided on its outer surface with a protective layer 2. The gel 13 is a plasticizer-free gel and the functional layer configured as the support layer 3 is a contiguous coating of a traction layer of a fabric 5.

The support layer 3 is bonded by an intermediate layer 4 to the fabric 5, especially a textile fabric, of the traction layer. This fabric 5 is bonded by an additional intermediate layer 6 to another intermediate layer 7 which, in turn, is bonded to another intermediate layer 8 having a second fabric 9. On the fabric 9, on the bottom of the belt 1, designated as the running side 21, another layer 10 is applied onto a substrate in order to influence the running properties of the belt 1. In particular, the latter layer 10 can influence the coefficient of friction and the wear properties of the belt 1.

Moreover, FIG. 1 shows a side view of a joining area of a continuous joint 19 of the continuous belt 1 that joins a first belt end 17 to a second belt end 18 in the form of an overlapping joint. In the joining area, there is an adhesive layer 12 that serves to glue the first belt end 17 to the second belt end 18 and that serves as a covering 20 of a joining seam 22 on the support side 11 of the belt 1. For reasons having to do with the schematic depiction, a partial separation of the belt ends 17, 18 in the joining area that might have occurred because they were not fully joined by the adhesive layer 12 is only shown in the form of an apparent gap.

FIG. 2 shows a top view of a section of the continuous belt 1 depicted in FIG. 1, with a joining area 15 that is alternatively configured as a Z-joint, that is to say, a zigzag joint or dovetail joint, of a continuous joint. The belt 1 is joined at its belt ends 17, 18 along a Z-shaped, in other words, zigzag-shaped or dovetail-shaped, joining line 14 so as to form a continuous belt, whereby a joining zone on the support side is covered with a film 16 that forms a covering 20 (see FIG. 1). The side flanks 23, 24 of the belt 1 normally run parallel to each other and are shown curved in this figure only for purposes of illustrating the flexibility of the belt 1.

1-19. (canceled)

20: A multi-layered belt comprising:
a traction layer;
a functional layer containing a plasticizer-free gel, wherein the functional layer is a contiguous coating containing the gel.

21: The belt as recited in claim 20, wherein the gel is disposed on a support side of the belt and the functional layer with the gel forms a support layer.

22: The belt as recited in claim 20, wherein the gel includes at least one of polyurethane and silicone.

23: The belt as recited in claim 22, wherein the gel includes undercured polyurethane.

24: The belt as recited in claim 20, wherein the gel has long polymer filaments with a small number of linkages.

25: The belt as recited in claim 20, wherein that the gel has a high thermal conductivity.

26: The belt as recited in claim 20, wherein the gel includes a high molecular matrix and liquid dispersion agent permanently bonded to the matrix through secondary valence forces, wherein the matrix is 15% to 62% by weight, relative to a sum of the matrix and the liquid dispersion, and the liquid dispersion is 85% to 38% by weight, relative to the sun of the matrix and the liquid dispersion, wherein the high-molecular matrix is a covalently cross-linked polyurethane and the liquid dispersion agent is one or more polyhydroxyl compounds having a molecular weight between 1000 and 12,000 and an OH number between 20 and 112, wherein the dispersion agent essentially does not contain any hydroxyl compounds having a molecular weight under 800, wherein a product of functionalities of the components that form the polyurethane is at least 5.2 and an isocyanate characteristic number is between 15 and 60.

27: The belt as recited in claim 26, wherein the gel includes 0% to 100% by weight of fillers and/or additives, relative to the sum of the matrix and the liquid dispersion.

28: The belt as recited in claim 20, wherein the gel includes a gel compound based on reaction products of polyols and polyisocyanates, wherein the polyol component consists of a mixture of (I) one or more polyols having hydroxyl numbers of less than 112 and (II) one or more polyols having hydroxyl numbers in the range from 112 to 600, wherein a weight ratio of component I to component II is between 90:10 and 10:90, an isocyanate characteristic number of the reaction mixture is in the range from 15 to 59.81 and the product of the isocyanate functionality and the functionality of the polyol component is at least 6.15.

29: The belt as recited in claim 20, wherein the traction layer has a textile fabric.

30: The belt as recited in claim 21, further comprising a surface layer having a film or a coating disposed on the support side of the belt.

31: The belt as recited in claim 30, wherein the surface layer includes a sprayed-on coating.

32: The belt as recited in claim 30, wherein an outside of the surface layer includes structuring.

33: The belt as recited in claim 20, further comprising a continuous joint joining a first belt end to a second belt end.

34: The belt as recited in claim 33, wherein the continuous joint includes one of an overlapping joint and a Z-joint.

35: The belt as recited in claim 33, wherein the continuous joint includes an adhesive joint.

36: The belt as recited in claim 33, wherein the continuous joint includes a covering layer on the support side of the belt, the covering layer including a film

37: The belt as recited in claim 20, wherein the belt is one of a continuous treadmill belt, a conveyor belt and a processing belt.

38. The belt as recited in claim 20, wherein the belt is a treadmill belt for a person for training or fitness.

39: A method for the production of a multi-layered belt, the method comprising:
providing a traction layer; and
pouring a gel onto a traction layer in a continuous operation, wherein the pouring is performed by moving a reversing mixing and feeding unit back and forth perpendicular to a direction of movement of the traction layer so as to provide a gel layer with a uniform thickness onto the traction layer.

40: The method as recited in claim 39, further comprising feeding a film as a surface layer and inseparably bonding the film to the gel layer.
